(19) United States
(12) Patent Application Publication
(10) Pub. No.: US 2011/0294038 A1
(43) Pub. Date: Dec. 1, 2011

(54) ELECTRODE CATALYST FOR FUEL CELLS, METHOD OF PREPARING THE SAME, AND FUEL CELL INCLUDING ELECTRODE CONTAINING THE ELECTRODE CATALYST

(75) Inventors: Kyung-Jung KWON, Yongin-si (KR); Chan-Ho PAK, Seoul (KR); Seon-Ah JIN, Pocheon-si (KR); Kang-Hee LEE, Suwon-si (KR)

(73) Assignee: Samsung Electronics Co., Ltd., Suwon-si (KR)

(21) Appl. No.: 13/014,217

(22) Filed: Jan. 26, 2011

(30) Foreign Application Priority Data
May 26, 2010 (KR) 10-2010-0049116

(51) Int. Cl. H01M 8/10; H01M 8/00; H01M 4/38; B82Y 30/00

(52) U.S. Cl. 429/487; 429/525; 429/535; 977/742

(57) ABSTRACT

Electrode catalysts for fuel cells including a non-platinum (Pt) metal catalyst material including at least two metals, a metal oxide cocatalyst material, and at least one carbon support, methods of preparing the same, and fuel cells including the electrolyte catalysts.

### CROSS-REFERENCE TO RELATED APPLICATION

This application claims the benefit of Korean Application No. 10-2010-0049116, filed May 26, 2010, in the Korean Intellectual Property Office, the disclosure of which is incorporated herein by reference.

### BACKGROUND

1. Field

Aspects of the present disclosure relate to fuel cells, and more particularly, to non-platinum (Pt) based electrode catalysts for fuel cells, methods of preparing the same, and fuel cells including electrodes containing the electrode catalysts.

2. Description of the Related Art

Fuel cells, unlike typical batteries, are electricity-generation type cells that directly convert energy from chemical reactions between hydrogen and oxygen into electrical energy and may continuously generate electricity as long as hydrogen and oxygen is supplied. Unlike a typical electricity generation method in which efficiency is lost during various processes, fuel cells may directly generate electricity and thus their efficiency is about two times higher than that of internal-combustion engines. Also, problems such as environmental pollution and resource depletion may be reduced.

Fuel cells can be classified into polymer electrolyte membrane fuel cells (PEMFCs), direct methanol fuel cells (DMFCs), phosphoric acid fuel cells (PAFCs), molten carbonate fuel cells (MCFCs), and solid oxide fuel cells (SOFCs), according to the types of electrolyte and fuel used in the fuel cells.

In general, PEMFCs and DMFCs include a membrane-electrode assembly (MEA) consisting of an anode, a cathode, and a polymer electrolyte interposed between the anode and the cathode. An oxidation reaction involving fuel occurs in the anode when hydrogen or fuel is applied, hydrogen ions generated in the anode are transmitted to the cathode through the polymer electrolyte membrane, a reduction reaction involving oxygen is generated in the cathode when oxygen is supplied, and thus a voltage difference occurs between the anode and the cathode, thereby generating electricity.

A catalyst that facilitates the reaction for generating hydrogen ions by oxidizing fuel is included in the anode of fuel cells and a catalyst that facilitates reduction of oxygen is included in the cathode. Currently, a catalyst using platinum (Pt) as an active component is used in the anode and the cathode. However, there are only small reserves of Pt-based catalysts and Pt-based catalysts are expensive. Thus, the cost of using a Pt-based catalyst makes up a large portion of the entire cost of manufacturing fuel cells and thus mass production and commercialization thereof are difficult. Therefore, development of a non-Pt based catalyst and development of fuel cells having excellent performance using a non-Pt based catalyst are underway.

### SUMMARY

Aspects of the present invention provide non-platinum (Pt) based electrode catalysts for fuel cells having excellent hydrogen oxidation capability, methods of manufacturing the same, and fuel cells using the non-Pt based electrode catalysts.

According to an aspect of the present invention, an electrode catalyst for a fuel cell includes at least one carbon support; a non-platinum (Pt) metal catalyst material; and a metal oxide cocatalyst material where the non-Pt metal catalyst material and the metal oxide cocatalyst material are supported on the at least one carbon support. The non-Pt metal catalyst material includes an alloy of palladium (Pd) and at least one metal selected from the group consisting of iridium (Ir), cobalt (Co), nickel (Ni), vanadium (V), chromium (Cr), zinc (Zn), manganese (Mn), copper (Cu), iron (Fe), indium (In), tin (Sn), selenium (Se), cerium (Ce), and ruthenium (Ru).

According to another aspect of the present invention, a method of preparing the electrode catalyst includes mixing the non-Pt metal catalyst material supported on a first carbon support and a metal oxide cocatalyst material supported on a second carbon support.

According to another aspect of the present invention, a method of preparing the electrode catalyst includes: dissolving a non-Pt metal catalyst material precursor and a metal oxide cocatalyst material precursor in a solvent so as to form a solution; adding a single carbon support to the solution; stirring the resultant solution to disperse the non-Pt metal catalyst material precursor on the single carbon support; and the metal oxide cocatalyst material precursor on the single carbon support; and reducing the non-Pt metal catalyst material precursor and metal oxide cocatalyst material precursor dispersed on the single carbon support.

According to another aspect of the present invention, a fuel cell includes an electrode including the electrode catalyst for a fuel cell as described above and an electrolyte membrane.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a diagram schematically illustrating an electrode catalyst for a fuel cell, according to an embodiment of the present invention;

FIG. 1B is a diagram schematically illustrating an electrode catalyst for a fuel cell, according to another embodiment of the present invention;

FIG. 2A is a flowchart schematically illustrating a method of preparing the metal oxide cocatalyst material supported on a carbon support of FIG. 1A;

FIG. 2B is a flowchart schematically illustrating a method of preparing the non-platinum (Pt) metal catalyst material supported on a carbon support of FIG. 1A;

FIG. 3 is a flowchart schematically illustrating a method of preparing the electrode catalyst for a fuel cell of FIG. 1B;

FIG. 4 is a perspective exploded view of a fuel cell according to another embodiment of the present invention;

FIG. 5 is a cross-sectional view of a membrane-electrode assembly (MEA) of the fuel cell of FIG. 4;

FIG. 6 is a transmission electron microscopic (TEM) image of WO₃/C prepared according to Preparation Example 2;

FIGS. 7A through 7C are graphs showing results of energy dispersive X-ray spectroscopic (EDX) analysis for WO₃/C prepared according to Preparation Example 2;

FIG. 8 is a graph showing hydrogen oxidation reaction (HOR) activity evaluation of WO₃/C prepared according to Preparation Example 2; and

FIG. 9 is a graph showing performance evaluation results of polymer electrolyte membrane fuel cells (PEMFCs) manufactured in Examples 1-4 and Comparative Examples 1 and 2.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electrode catalyst for a fuel cell according to an embodiment of the present invention includes at least one carbon support; a non-platinum (Pt) metal catalyst material; and a metal oxide cocatalyst material, where the non-platinum (Pt) metal catalyst material and the metal oxide cocatalyst material are supported on the at least one carbon support, and where the non-Pt metal catalyst material includes an alloy of palladium (Pd) and at least one metal selected from the group consisting of iridium (Ir), cobalt (Co), nickel (Ni), vanadium (V), chromium (Cr), zinc (Zn), manganese (Mn), copper (Cu), iron (Fe), indium (In), tin (Sn), selenium (Se), cerium (Ce), and ruthenium (Ru).

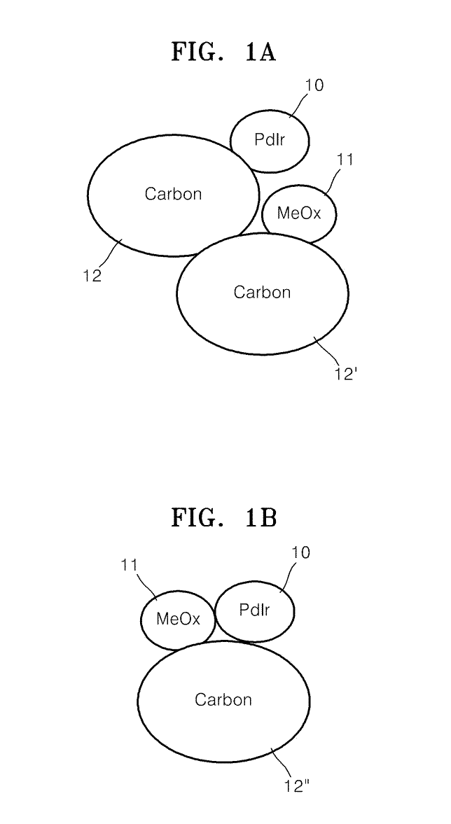

FIGS. 1A and 1B are diagrams schematically illustrating electrode catalysts for fuel cells according to embodiments of the present invention. In the electrode catalyst of FIG. 1A, a non-Pt metal catalyst material 10, for example, PdIr, supported on a first carbon support 12 and a metal oxide (MeOₓ) cocatalyst material 11 supported on a second carbon support 12′ may co-exist. That is, the non-Pt metal catalyst material 10 and the metal oxide cocatalyst material 11 are supported on the first and second carbon supports 12 and 12′, respectively, and are then mixed. Here, the amount of the non-Pt metal catalyst material 10 supported on the first carbon support 12 may be in the range of about 5 to about 70 weight % based on the total weight of the first and second carbon supports 12 and 12′. If the amount is within the above range, a catalyst having a particle size of 10 nm or less may be prepared.

In the electrode catalyst of FIG. 1B, the non-Pt metal catalyst material 10, for example, PdIr, and the metal oxide (MeOₓ) cocatalyst material 11 are supported on the same carbon support, for example, a single carbon support 12″. That is, the non-Pt metal catalyst material 10 and the metal oxide cocatalyst material 11 are simultaneously supported on the single carbon support 12″. Here, the amount of the non-Pt metal catalyst material 10 supported on the single carbon support 12″ may be in the range of about 5 to about 70 weight % based on the total weight of the single carbon support 12″. If the amount is within the above range, a catalyst having a particle size of 10 nm or less may be prepared.

In the electrode catalysts for a fuel cell according to the embodiments of the present invention described above, the metal oxide cocatalyst material may be an oxide of at least one metal selected from the group consisting of tungsten (W), molybdenum (Mo), niobium (Nb), vanadium (V), zirconium (Zr), and titanium (Ti).

The carbon supports may include Ketjen Black, carbon black, graphite carbon, carbon nanotubes, or carbon fiber.

The non-Pt metal catalyst material may be an alloy of palladium (Pd) and at least one metal selected from the group consisting of iridium (Ir) and ruthenium (Ru). In the alloy, the weight ratio of palladium (Pd) and the at least one selected metal may be between 100:1 and 1:100.

The non-Pt metal catalyst material supported on the carbon support may have an average diameter of about 1 to about 10 nm. If the average diameter of the non-Pt metal catalyst material 10 is within the above range, hydrogen oxidation activity may be excellent.

In the electrode catalysts for a fuel cell according to the embodiments of the present invention described above, the amount of the metal oxide cocatalyst material may be in the range of about 0.01 to about 50 parts by weight based on 100 parts by weight of the non-Pt metal catalyst material. If the amount of the metal oxide cocatalyst material is within the above range, hydrogen oxidation reaction (HOR) activity of the non-Pt metal catalyst material may be maximized.

According to an embodiment of the present invention, an electrode catalyst for a fuel cell may be prepared by mixing a non-Pt metal catalyst material including at least two metals supported on a first carbon support with a metal oxide cocatalyst material supported on a second carbon support.

The non-Pt metal catalyst material supported on the first carbon support may be obtained by dissolving a non-Pt metal catalyst material precursor in a solvent to form a solution for a catalyst material; adding the first carbon support to the solution for a catalyst material; stirring the resultant solution to disperse the non-Pt metal catalyst material precursor on the first carbon support; and reducing the non-Pt metal catalyst material precursor dispersed on the first carbon support.

The metal oxide cocatalyst material supported on a second carbon support may be obtained by dissolving a metal oxide cocatalyst material precursor in a solvent so as to form a solution for a cocatalyst material; adding the second carbon support to the solution for a cocatalyst material; and stirring the resultant solution to disperse the metal oxide cocatalyst material precursor on the second carbon support; and calcining the metal oxide cocatalyst material precursor dispersed on the second carbon support.

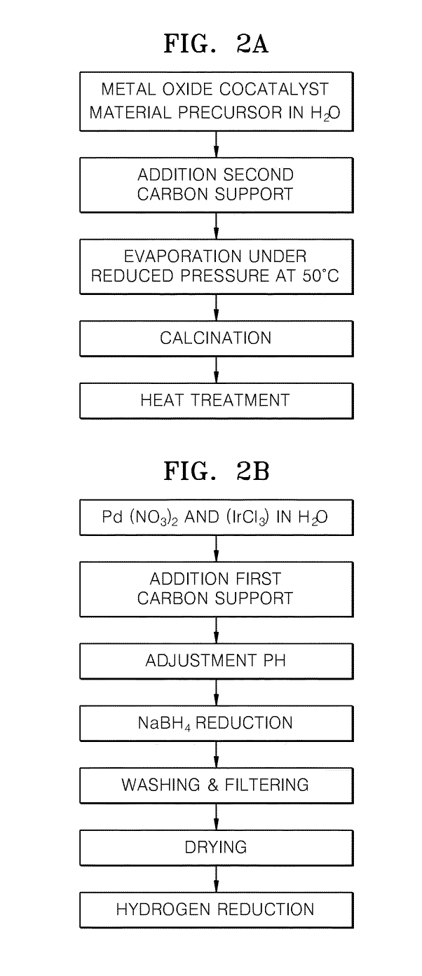

FIGS. 2A and 2B are flowcharts schematically illustrating methods of preparing the electrode catalyst for the fuel cell of FIG. 1A. According to an embodiment of the present invention, the non-Pt metal catalyst material 10 and the metal oxide cocatalyst material 11 are respectively supported on the first and second carbon supports 12 and 12′ and the supported non-Pt metal catalyst material 10 is mixed with the supported metal oxide cocatalyst material 11, thereby preparing the electrode catalyst for a fuel cell of FIG. 1A.

Referring to FIG. 2A, a metal oxide cocatalyst material precursor is dissolved in a solvent, for example, water, so as to form a solution for a cocatalyst material. Next, the second carbon support 12′ is added to the solution for the cocatalyst material and then the solution is stirred to disperse the metal oxide cocatalyst material precursor on the second carbon support 12′. Afterward, the metal oxide cocatalyst material precursor dispersed on the second carbon support 12′ is calcined, thereby obtaining the metal oxide cocatalyst material 11 supported on the second carbon support 12′. The dispersion may be performed by evaporation of the solution for a cocatalyst material at room temperature to about 100° C., for example, 50° C., under reduced pressure. The calcination process may be performed under an ambient atmosphere at a temperature of about 150° C. or above, for example, 300° C. Here, in order to improve crystallinity of the metal oxide cocatalyst material 11, the metal oxide cocatalyst material 11 supported on the second carbon support 12′ may be thermally treated at a temperature higher than that of the calcination, for example, at about 450° C., under an inert gas atmosphere.

Referring to FIG. 2B, a non-Pt metal catalyst material precursor including at least two metals, for example, Pd(NO₃)₂ and IrCl₃, are dissolved in a solvent, for example, H₂O, so as to form a solution for a catalyst material. Next, the first carbon support 12 is added to the solution for a catalyst material and then the solution is stirred to disperse the non-Pt metal catalyst material precursor on the first carbon support 12. Afterward, the non-Pt metal catalyst material precursor dispersed on the first carbon support 12 is reduced, thereby obtaining the non-Pt metal catalyst material 10 supported on the first carbon support 12.

The non-Pt metal catalyst material precursor may be reduced by adding NaOH so as to adjust pH to, for example, 11, and by using a reducing agent, for example, an NaBH₄ aqueous solution. The non-Pt metal catalyst material obtained after the reducing process may be washed and dried and then reduced under a hydrogen atmosphere.

The non-Pt metal catalyst material 10 supported on the first carbon support 12 may be mixed with the metal oxide cocatalyst material 11 supported on the second carbon support 12′, thereby obtaining the electrode catalyst for a fuel cell of FIG. 1A. Here, the metal oxide cocatalyst material 11 supported on the second carbon support 12′ may be firstly prepared and then the non-Pt metal catalyst material 10 supported on the first carbon support 12 may be prepared. The mixed catalyst material may be dried at about 50° C. by distillation under reduced pressure.

According to another embodiment of the present invention, an electrode catalyst for a fuel cell may be prepared by using a method including: dissolving a non-Pt metal catalyst material precursor and a metal oxide cocatalyst material precursor in a solvent so as to form a solution; adding a single carbon support to the solution; stirring the resultant solution to disperse the non-Pt metal catalyst material precursor and the metal oxide cocatalyst material precursor on the single carbon support; and reducing the non-Pt metal catalyst material precursor and the metal oxide cocatalyst material precursor dispersed on the single carbon support.

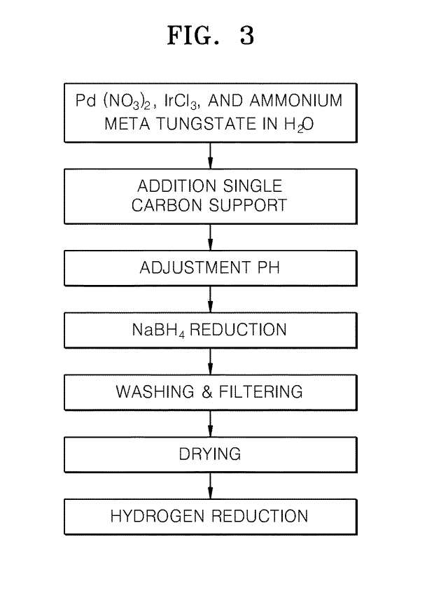

FIG. 3 is a flowchart schematically illustrating a method of preparing the electrode catalyst for a fuel cell of FIG. 1B. The method of preparing the electrode catalyst for a fuel cell is described with reference to FIG. 3.

A non-Pt metal catalyst material precursor including at least two metals and a metal oxide cocatalyst material precursor are dissolved in a solvent so as to form a solution. Next, the single carbon support 12″ is added to the solution and then the solution is stirred to disperse the non-Pt metal catalyst material precursor and the metal oxide cocatalyst material precursor on the single carbon support 12″. Then, the non-Pt metal catalyst material precursor and the metal oxide cocatalyst material precursor dispersed on the single carbon support 12″ are reduced, thereby obtaining the non-Pt metal catalyst material 10 and the metal oxide cocatalyst material 11 supported on the single carbon support 12″.

The non-Pt metal catalyst material precursor may be reduced by adding NaOH so as to adjust pH to, for example, 11, and using a reducing agent, for example, a NaBH₄ aqueous solution. The obtained catalyst material is filtered, dried, and then hydrogen reduced. Hydrogen reduction may be performed at a temperature in the range of about 100 to about 300° C. The obtained catalyst material may be dried at about 50° C. by evaporation under reduced pressure.

The non-Pt metal catalyst material precursor may include at least one salt of a non-Pt metal, the salt selected from the group consisting of a chloride, a nitride, a sulfide, an acetylacetonate, and a cyanide of. The metal oxide cocatalyst material precursor may include at least one salt of a metal, the salt selected from the group consisting of a nitride, a chloride, a sulfide, an acetate, an acetylacetonate, cyanide, an isopropyl oxide, and a butoxide. The metal oxide cocatalyst material precursor may be a precursor of at least one metal selected from the group consisting of tungsten (W), molybdenum (Mo), niobium (Nb),vanadium (V), zirconium (Zr), and titanium (Ti).

The solvent may be, for example, distilled water, hydrochloric acid, nitric acid, acetone, ethanol, or isopropyl alcohol. A material used to form the single carbon support 12″ may be, for example, Ketjen Black, carbon black, graphite carbon, carbon nanotubes, ordered porous carbon, or carbon fiber.

Another embodiment of the present invention provides a fuel cell including an electrode that contains one of the electrode catalysts for a fuel cell described above; and an electrolyte membrane. The electrode may be an anode or a cathode.

The fuel cell includes an anode, a cathode, and an electrolyte membrane interposed between the anode and the cathode. The anode generates hydrogen ions and electrons due to a hydrogen oxidation reaction (HOR) (H₂→2H⁺+2e⁻), protons (H⁺) are diffused to the cathode through the electrolyte membrane, and electrons are moved along an external circuit. An oxygen reduction reaction (ORR) occurs in the cathode and water is generated (2H⁺+2e⁻+½O₂→H₂O). Here, protons (H⁺) are provided from the electrolyte membrane and electrons are provided from the external circuit.

The electrode catalyst for a fuel cell may be applied to the anode of the fuel cell in which an HOR occurs and thus a fuel cell including the anode having excellent hydrogen oxidation capability may be provided. The fuel cell may be implemented as, for example, a phosphoric acid fuel cell (PAFC), a polymer electrolyte membrane fuel cell (PEMFC), or a direct methanol fuel cell (DMFC). Also, the electrode catalyst for a fuel cell may be applied to a cathode of a fuel cell.

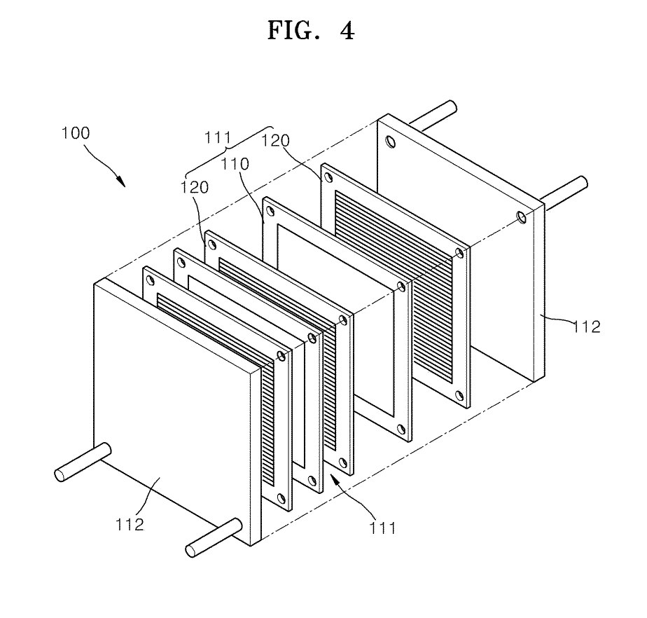

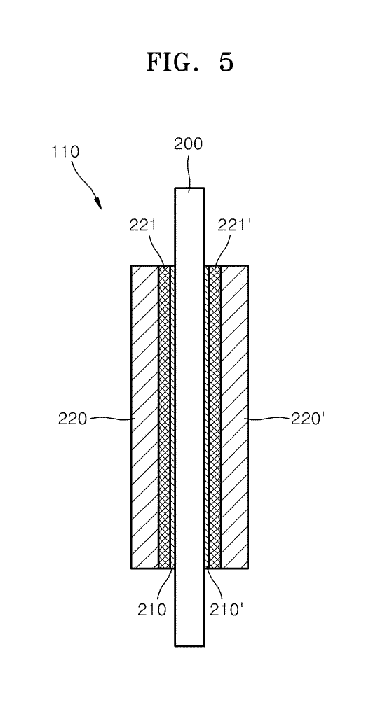

FIG. 4 is a perspective exploded view of a fuel cell 100 according to an embodiment of the present invention and FIG. 5 is a cross-sectional view of a membrane-electrode assembly (MEA) 110 of the fuel cell 100 of FIG. 4.

Referring to FIG. 4, the fuel cell 100 includes two unit cells 111 that are supported by a pair of holders 112. Each unit cell 111 includes the MEA 110 and bipolar plates 120 disposed on opposite sides of the MEA 110. The bipolar plates 120 may each include a conductive metal, carbon, or the like, and bond to the MEA 110, function as current collectors, and provide oxygen or fuel to catalyst layers of the MEAs 110. Although only two unit cells 111 are shown in the fuel cell 100 of FIG. 4, the number of unit cells is not limited to two and a fuel cell may have several tens or hundreds of unit cells, depending on the required properties of the fuel cell.

Referring to FIG. 5, each MEA 110 includes an electrolyte membrane 200; catalyst layers 210 and 210′ respectively disposed on opposite sides of the electrolyte membrane 200 in the thickness direction thereof; first gas diffusion layers 221 and 221′ respectively stacked on the catalyst layers 110 and 110′; and second gas diffusion layers 220 and 220′ respectively stacked on the first gas diffusion layers 221 and 221′, wherein one of the catalyst layers 210 and 210′ includes the electrode catalyst according to previously described embodiments of the present invention.

The catalyst layers 210 and 210′ respectively function as a fuel electrode and an oxygen electrode, and each includes a catalyst and a binder therein. The catalyst layers 210 and 210′ may further include a material that may increase the electrochemical surface area of the catalyst.

The first gas diffusion layers 221 and 221′ and the second gas diffusion layers 220 and 220′ may each be formed of a material such as, for example, carbon sheet or carbon paper. The first gas diffusion layers 221 and 221′ and the second gas diffusion layers 220 and 220′ diffuse oxygen and fuel supplied through the bipolar plates 120 into the entire surfaces of the catalyst layers 210 and 210′.

The fuel cell 100 including the MEA 110 operates at a temperature of about 50 to about 300° C. Fuel such as hydrogen is supplied through one of the bipolar plates 120 into one of the catalyst layers 210 and 210′, and an oxidant such as oxygen is supplied through another bipolar plate 120 into the other catalyst layer 210 or 210′. Then, hydrogen is oxidized into protons (H⁺) in the catalyst layer 210 or 210′, and the protons (H⁺) are conducted to the other catalyst layer 210 or 210′ through the electrolyte membrane 200. Then, the protons (H⁺) electrochemically react with oxygen in the other catalyst layer 210 or 210′ to produce water (H₂O) and generate electrical energy. Moreover, hydrogen supplied as a fuel may be hydrogen produced by reforming hydrocarbons or alcohols. Oxygen supplied as an oxidant may be supplied in the form of ambient atmosphere.

One or more embodiments will now be described in more detail with reference to the following examples. However, these examples are for illustrative purposes only and are not intended to limit the scope of the present invention.

### PREPARATION EXAMPLE 1

### Preparation of PdIr/C

1.4 g of palladium nitrate and 0.4 g of iridium chloride were dissolved in 300 g of water so as to prepare a solution. Then, 0.5 g of Ketjen Black (surface area=800 m²/g) as a first carbon support were added to the solution and 5 g of a NaOH aqueous solution were added to the solution to adjust pH to 11. Then, the metal ions were reduced by slowly adding 50 g of an NaBH₄ aqueous solution having a concentration of 5%. The resultant was stirred for about 12 hours at 300 rpm and then filtered. The filtered resultant was washed and dried. The resultant was reduced at 300° C. by using hydrogen and PdIr supported on the first carbon support was obtained.

### PREPARATION EXAMPLE 2

### Preparation of WO₃/C

0.057 g of ammonium metatungstate were dissolved in 80 g of water, 1 g of Ketjen Black (surface area=800 m²/g) as a second carbon support were added thereto, and then the solution was stirred. The resultant was evaporated under reduced pressure at about 50° C. and a tungsten precursor was dispersed on the second carbon support. Then, the resultant was calcined under ambient atmosphere at 300° C., and thus oxidized tungsten supported on the second carbon support was obtained.

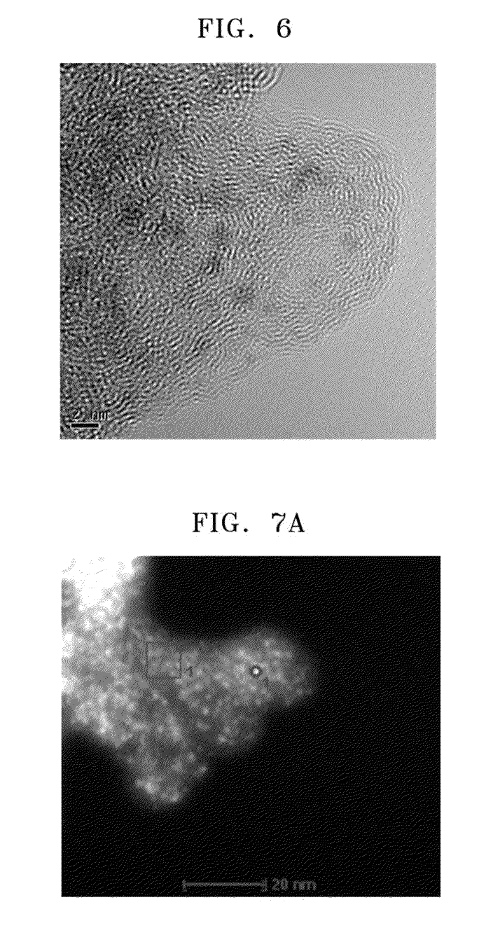

The resultant was analyzed using a transmission electron microscope (TEM) and the result thereof is shown in FIG. 6. As shown in FIG. 6, small black particles of about 1 to 2 nm are uniformly diffused. However, crystallinity cannot be identified due to electron scattering of the second carbon support.

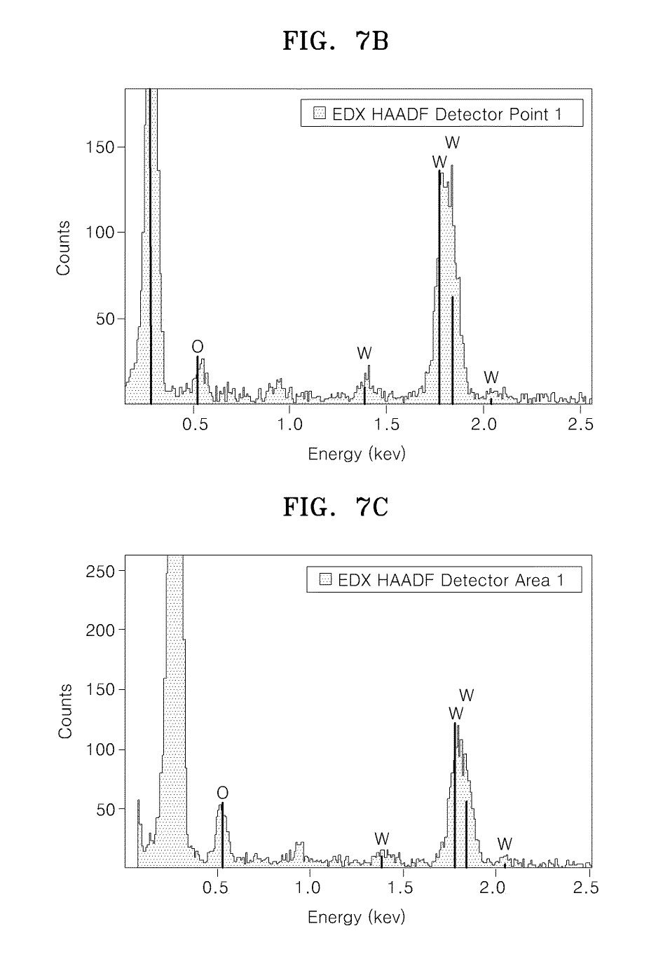

The resultant was also analyzed by using an energy dispersive X-ray spectroscope (EDX) and the results thereof are shown in FIGS. 7A through 7C. Elemental analysis of the portion indicated by the square in FIG. 7A is illustrated in FIG. 7B and elemental analysis of the portion indicated by the circle in FIG. 7A is illustrated in FIG. 7C. In FIG. 7B, where relatively large particles from the square of FIG. 7A exist and in FIG. 7C, where small particles from the circle of FIG. 7A exist, elements W and O were simultaneously detected. This indicates that WO₃ is uniformly distributed in the second carbon support.

### PREPARATION EXAMPLE 3

### Preparation of PdIr—WO₃/C

0.98 g of palladium nitrate, 0.37 g of iridium chloride, and 0.018 g of ammonium metatungstate were dissolved in 300 g of water. 0.5 g of Ketjen Black as a single carbon support were added to the resultant solution and then a 20% NaOH aqueous solution was added thereto so as to adjust pH to 11.5. Then, 101 g of an NaBH₄ aqueous solution manufactured by dissolving 1 g of NaBH₄ into 100 g of water was slowly added to the resultant. The resultant was stirred for about 1 hour and filtered, washed, and dried. Then, the resultant was reduced for about 2 hours and a catalyst in which PdIr and WO₃ were simultaneously supported on the single carbon support was prepared.

### PREPARATION EXAMPLE 4

### Preparation of PdRu—WO₃/C

A catalyst in which PdRu and WO₃ were simultaneously supported on a single carbon support was prepared in the same manner as in Preparation Example 3 except that 0.36 g of ruthenium chloride were used instead of iridium chloride.

### PREPARATION EXAMPLE 5

### Preparation of MoO₃/C

A cocatalyst material in which molybdenum oxide is supported on a second carbon support was obtained in the same manner as in Preparation Example 2 except that 0.065 g of ammonium metamolybdate were used instead of ammonium metatungstate.

Measurement of Hydrogen Oxidation Reaction (HOR) Activity

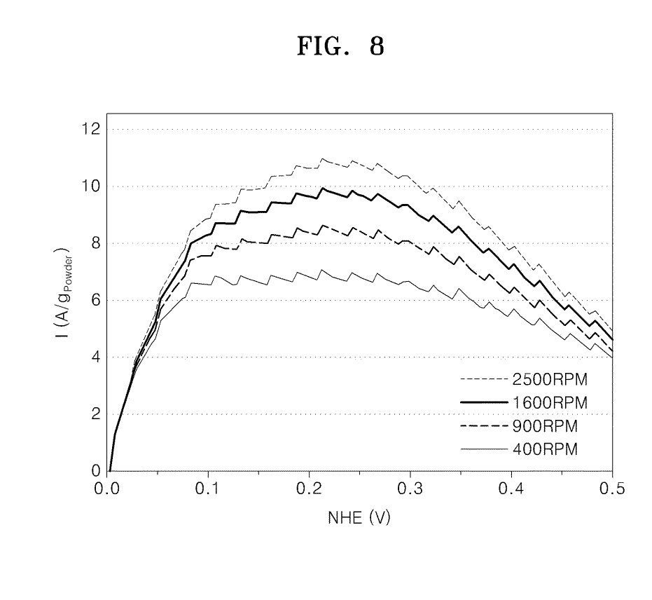

HOR activity of the catalysts was evaluated by using a rotating disk electrode (RDE). An RDE was prepared in the form of a thin film by dispersing WO₃/C powder manufactured according to Preparation Example 2 and a Nafion binder in an aqueous solution and then coating the solution on glassy carbon. Electrochemical evaluation was performed using a three-electrode system, a hydrogen-saturated 0.1 M-HClO₄ solution as an electrolyte, and a Pt foil and an Ag/AgCl electrode, respectively, as a counter electrode and a reference electrode. All electrochemical experiments were performed at room temperature. The results are shown in FIG. 8. In FIG. 8, the vertical axis indicates a current I normalized by the catalyst amount g and the horizontal axis indicates a potential V converted to that of a normal hydrogen electrode (NHE). As rotation speed of the RDE increases from 400 rpm to 2500 rpm, hydrogen is increasingly supplied to the RDE and thereby oxidization current increases, which is evidence of HOR activity. This indicates that the metal oxide had catalytic activity.

### EXAMPLE 1

### Fuel Cell Including Electrode Containing PdIr/C+WO₃/C Catalyst

In order to prepare an anode of a PEMFC, a slurry for forming an anode was prepared by mixing 0.03 g of polyvinylidene fluoride (PVDF) and an appropriate amount of a solvent, n-methyl-2-pyrrolidone, for every 1 g of a catalyst (PdIr/C of Preparation Example 1 and WO₃/C of Preparation Example 2 mixed at a weight ratio of 4:1). The anode slurry was coated on a microporous layer-coated carbon paper using a bar coater, and the resultant was dried while the temperature was stepwise increased from room temperature to 150° C., thereby producing an anode.

Separately, a cathode was prepared in the same manner as described above in the preparation of the anode, using a carbon-supported Pt—Co catalyst (available from Tanaka Precious Metals, Pt: 45 wt %, Co: 5 wt %).

A PEMFC was prepared by disposing poly(2,5-benzimidazole) doped with a 85% phosphoric acid as an electrolyte membrane between the anode and the cathode.

Then, performance of the PEMFC was evaluated at about 150° C. using non-humidified air and non-humidified hydrogen for the cathode and the anode, respectively.

### EXAMPLE 2

### Fuel Cell Including Electrode Containing PdIr—WO₃/C Catalyst

A PEMFC was manufactured and its performance was evaluated in the same manner as in Example 1, except that a slurry for forming an anode was prepared by mixing 0.03 g of polyvinylidene fluoride (PVDF) and an appropriate amount of a solvent, n-methyl-2-pyrrolidone, for every 1 g of the PdIr—WO₃/C catalyst prepared according to Preparation Example 3.

### EXAMPLE 3

### Fuel Cell Including Electrode Containing PdRu—WO₃/C Catalyst

A PEMFC was manufactured and its performance was evaluated in the same manner as in Example 1, except that a slurry for forming an anode was prepared by mixing 0.03 g of polyvinylidene fluoride (PVDF) and an appropriate amount of a solvent, n-methyl-2-pyrrolidone, for every 1 g of the PdRu—WO₃/C catalyst prepared according to Preparation Example 4.

### EXAMPLE 4

### Fuel Cell Including Electrode Containing PdIr/C+MoO₃/C Catalyst

A PEMFC was manufactured and its performance was evaluated in the same manner as in Example 1, except that a slurry for forming an anode was prepared by mixing 0.03 g of polyvinylidene fluoride (PVDF) and an appropriate amount of a solvent, n-methyl-2-pyrrolidone, for every 1 g of a mixture of PdIr/C and MoO₃/C prepared according to Preparation Example 1 and Preparation Example 5, respectively, mixed at a weight ratio of 4:1.

### COMPARATIVE EXAMPLE 1

### Fuel Cell Including Electrode Containing PdIr/C Catalyst

A PEMFC was manufactured and its performance was evaluated in the same manner as in Example 1, except that a slurry for forming an anode was prepared by mixing 0.03 g of polyvinylidene fluoride (PVDF) and an appropriate amount of a solvent, n-methyl-2-pyrrolidone, for every 1 g of the PdIr/C catalyst prepared according to Preparation Example 1.

### COMPARATIVE EXAMPLE 2

### Fuel Cell Including Electrode Containing WO₃/C Catalyst

A PEMFC was manufactured and its performance was evaluated in the same manner as in Example 1, except that a slurry for forming an anode was prepared by mixing 0.03 g of polyvinylidene fluoride (PVDF) and an appropriate amount of a solvent, n-methyl-2-pyrrolidone, for every 1 g of the WO₃/C catalyst prepared according to Preparation Example 2.

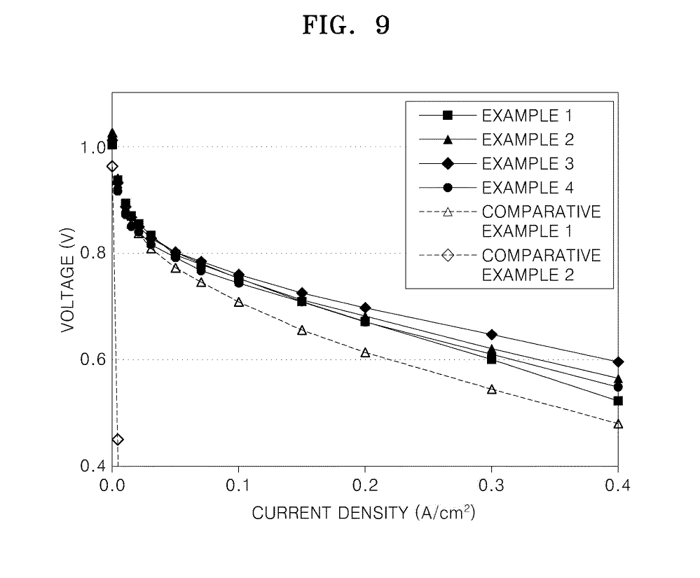

FIG. 9 is a graph showing performance evaluation results of the PEMFCs manufactured in Examples 1-4 and Comparative Examples 1 and 2. In the performance evaluation, the PEMFCs were operated at about 150° C. using non-humidified air and non-humidified hydrogen for the cathode and the anode, respectively. The performance evaluation was performed in such a way that current density increased stepwise from 0 to about 0.4 A/cm² and corresponding operational voltages were recorded.

As shown in FIG. 9, although the WO₃/C catalyst has HOR activity as shown in FIG. 8 when it is used alone in the anode, the performance of the PEMFC in Comparative Example 2 is very low. However, the performance of the PEMFC is improved when WO₃/C is added to PdIr/C as a cocatalyst in the electrode slurry (Example 1), when PdIr—WO₃/C is used as a catalyst (Example 2), when PdRu—WO₃/C is used as a catalyst (Example 3), and when MoO₃/C is added to PdIr/C as a cocatalyst (Example 4) in all current density regions.

According to the embodiments of the present invention, a catalyst for a fuel cell having catalytic activity similar with that of a Pt catalyst may be obtained without using a Pt catalyst.

As described above, according to the one or more of the above embodiments of the present invention, even if a non-Pt metal catalyst material is used in an electrode catalyst for a fuel cell, a fuel cell having similar efficiency with a Pt-based catalyst may be prepared with a lower cost.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode catalyst for a fuel cell, comprising:
at least one carbon support;
a non-platinum (Pt) metal catalyst material; and
a metal oxide cocatalyst material,
wherein the non-Pt metal catalyst material and the metal oxide cocatalyst material are supported on the at least one carbon support, and
the non-Pt metal catalyst material comprises an alloy of palladium (Pd) and at least one metal selected from the group consisting of iridium (Ir), cobalt (Co), nickel (Ni), vanadium (V), chromium (Cr), zinc (Zn), manganese (Mn), copper (Cu), iron (Fe), indium (In), tin (Sn), selenium (Se), cerium (Ce), and ruthenium (Ru).

2. The electrode catalyst of claim 1, wherein the non-Pt metal catalyst material comprises an alloy of palladium (Pd) and at least one metal selected from the group consisting of iridium (Ir) and ruthenium (Ru).

3. The electrode catalyst of claim 1, wherein the metal oxide cocatalyst material comprises oxides of at least one metal selected from the group consisting of tungsten (W), molybdenum (Mo), niobium (Nb),vanadium (V), zirconium (Zr), and titanium (Ti).

4. The electrode catalyst of claim 1, wherein the amount of the metal oxide cocatalyst material is in the range of about 0.01 to about 50 parts by weight based on 100 parts by weight of the non-Pt metal catalyst material.

5. The electrode catalyst of claim 1, wherein the at least one carbon support is at least one material selected from the group consisting of Ketjen Black, carbon black, graphite carbon, carbon nanotubes, ordered porous carbon, and carbon fiber.

6. The electrode catalyst of claim 1, wherein the at least one carbon support comprises a first carbon support supporting the non-Pt metal catalyst material and a second carbon support supporting the metal oxide cocatalyst material.

7. The electrode catalyst of claim 6, wherein the amount of the non-Pt metal catalyst material supported on the first carbon support is in the range of about 5 to about 70 weight % based on the total weight of the at least one carbon suport.

8. The electrode catalyst of claim 1, wherein the at least one carbon support comprises a single carbon support supporting the non-Pt metal catalyst material and the metal oxide cocatalyst material.

9. The electrode catalyst of claim 8, wherein the amount of the non-Pt metal catalyst material supported on the single carbon support is in the range of about 5 to about 70 weight % of the total weight of the single carbon support.

10. A method of preparing the electrode catalyst of claim 6, the method comprising mixing a non-Pt metal catalyst material supported on a first carbon support and a metal oxide cocatalyst material supported on a second carbon support.

11. The method of claim 10, wherein the non-Pt metal catalyst material supported on the first carbon support is obtained by using a method comprising:
dissolving a non-Pt metal catalyst material precursor in a solvent to form a solution for a catalyst material;
adding the first carbon support to the solution for a catalyst material;
stirring the resultant solution to disperse the non-Pt metal catalyst material precursor on the first carbon support; and
reducing the non-Pt metal catalyst material precursor dispersed on the first carbon support.

12. The method of claim 10, wherein the metal oxide cocatalyst material supported on the second carbon support is obtained by using a method comprising:
dissolving a metal oxide cocatalyst material precursor in a solvent so as to form a solution for a cocatalyst material;
adding the second carbon support to the solution for a cocatalyst material;
stirring the resultant solution to disperse the metal oxide cocatalyst material precursor on the second carbon support; and
calcining the metal oxide cocatalyst material precursor dispersed on the second carbon support.

13. A method of preparing the electrode catalyst of claim 8, the method comprising:
dissolving a non-Pt metal catalyst material precursor and a metal oxide cocatalyst material precursor in a solvent so as to form a solution;
adding a single carbon support to the solution;
stirring the resultant solution to disperse the non-Pt metal catalyst material precursor and the metal oxide cocatalyst material precursor on the single carbon support; and
reducing the non-Pt metal catalyst material precursor and metal oxide cocatalyst material precursor dispersed on the single carbon support.

14. The method of claim 12, further comprising thermally treating the obtained metal oxide cocatalyst material supported on the second carbon support under an inert gas atmosphere.

15. The method of claim 10, wherein the metal oxide cocatalyst material precursor includes at least one salt of a metal, the salt selected from the group consisting of a nitride, a chloride, a sulfide, an acetate, an acetylacetonate, a cyanide, an isopropyl oxide, and a butoxide.

16. The method of claim 10, wherein the non-Pt metal catalyst material precursor comprises at least one salt of the non-Pt metal, the salt selected from the group consisting of a chloride, a nitride, a sulfide, an acetylacetonate, and a cyanide.

17. A fuel cell comprising:
an electrode comprising the electrode catalyst for a fuel cell of claim 1; and
an electrolyte membrane.

18. The method of claim 13, wherein the metal oxide cocatalyst material precursor includes at least one salt of a metal, the salt selected from the group consisting of a nitride, a chloride, a sulfide, an acetate, an acetylacetonate, a cyanide, an isopropyl oxide, and a butoxide.

19. The method of claim 13, wherein the non-Pt metal catalyst material precursor comprises at least one salt of the non-Pt metal selected, the salt selected from the group consisting of a chloride, a nitride, a sulfide, an acetylacetonate, and a cyanide.
